(19) United States
(12) Patent Application Publication
(10) Pub. No.: US 2016/0021919 A1
(43) Pub. Date: Jan. 28, 2016

(54) METHODS OF STIMULATING INFANT LUNG AND GUT MATURATION

(71) Applicant: ABBOTT LABORATORIES, Abbott Park, IL (US)

(72) Inventors: Chron-Si Lai, Blacklick, OH (US); Randal Buddington, Memphis, TN (US)

(73) Assignee: ABBOTT LABORATORIES, Abbott Park, IL (US)

(21) Appl. No.: 14/774,592

(22) PCT Filed: Mar. 13, 2014
(86) PCT No.: PCT/US2014/025921

§ 371 Date: Sep. 10, 2015

Related U.S. Application Data
(60) Provisional application No. 61/778,949, filed on Mar. 13, 2013.
(60) Provisional application No. 61/778,959, filed on Mar. 13, 2013.

(51) Int. Cl. A23L 1/29; A23L 1/30

(52) U.S. Cl. CPC A23L 1/296; A23L 1/3008; A23L 1/3012; A23V 2002/00

(57) ABSTRACT

A method of enhancing maturation of a lung, gut, or both in an infant. The method includes the step of administering to the infant a nutritional composition including from about 3 weight % phospholipids to about 20 weight % phospholipids, based on total fat of the nutritional composition.

### CROSS-REFERENCE TO RELATED APPLICATIONS

This application claims priority to and any benefit of U.S. Provisional Application No. 61/778,949, filed Mar. 13, 2013, the entire contents of which are incorporated by reference in its entirety. This application also claims priority to and any benefit of U.S. Provisional Application No. 61/778,959, filed Mar. 13, 2013, the entire contents of which are incorporated by reference in its entirety.

### FIELD OF THE DISCLOSURE

The present disclosure relates to a method of enhancing maturation of a lung, gut, or both in an infant. In particular, the method includes the step of administering a nutritional composition to the infant.

### BACKGROUND OF THE DISCLOSURE

Infants born preterm who have immature lungs often develop respiratory distress syndrome (“infant respiratory distress syndrome” or “IRDS”) caused by developmental insufficiency of surfactant production and structural immaturity in the lungs. The disorder can also result from a genetic problem with the production of surfactant associated proteins. As such, IRDS affects about 1% of newborn term infants and is the leading cause of death in preterm infants. Currently, surfactant treatments, steroid treatments and ventilation strategies are employed to improve development of the lungs in preterm infants. However, preterm infants born extremely early have lungs with small lung gas volumes and delicate lung tissue that is susceptible to injury when using ventilation methods. Thus, standard treatments pose a risk of postnatal injury. (Jobe, et al., “Lung Development and Function in Preterm Infants in the Surfactant Treatment Era,” Annual Review of Physiology, Vol. 62: 825-846 (2000)).

It is also estimated that 20% of newborn infants have tolerance issues with infant formula. Formula intolerance may be related to perceived symptoms of constipation, fussiness, abdominal cramps, and excessive spit-up or vomit. These symptoms of intolerance may be due to a less mature gut. Before birth, the fetus receives a constant flow of maternal elemental nutrients via the placenta. After birth, the neonate must adjust to a variable uptake of nutrients from milk, which are available only after specialized digestive processes have occurred in the gastrointestinal tract (GIT). The final maturation of the GIT for enteral nutrient intake occurs shortly before or after term. Thus, even term infants' digestive systems may not be fully developed. As a result, they may experience gastrointestinal stress when fed infant formula.

The digestive system of preterm infants is generally not fully developed, yet such infants require additional nutrients for catch-up growth. Unfortunately, enteral nutrition (EN) feeding can be too aggressive and lead to necrotizing enterocolitis (NEC). It is believed that gut immaturity is one of the major causes of NEC, as this condition is very rare among term infants. As such, promoting gut maturation may help term infants grow out of tolerance issues more quickly, and may accelerate EN feeding schedules for preterm infants by improving digestion, absorption, and utilization of nutrients for catch-up growth. Currently, infant formulas typically use hydrolyzed protein or replace lactose with maltodextrin to reduce the severity of the tolerance problem. Current formulas do not, however, address the problem of gut maturation. To manufacture preterm infant formulas, a medium chain oil system is used in place of a long chain oil system. The change of oil system improves fat digestion rate, but does not improve growth rate. Thus, the use of medium chain oils does not improve the process of preterm infant gut maturation.

### SUMMARY OF THE DISCLOSURE

Disclosed herein are methods of enhancing maturation of a lung, gut, or both in an infant. The method includes the step of administering a nutritional composition including from about 3% to about 20% phospholipids, based on the total fat of the nutritional composition, to an infant.

### BRIEF DESCRIPTION OF THE DRAWINGS

FIG. 1 depicts the effect of dietary phospholipids on Litter A preterm piglet lung associated protein A synthesis.

FIG. 2 depicts the effect of dietary phospholipids on Litter B preterm piglet lung associated protein A synthesis.

FIG. 3 depicts total small intestine (“SI”) length in pigs fed formulas containing medium chain triglycerides (“MCT”), egg phospholipids (“Egg PL”), or soy phospholipids (“Soy PL”).

FIG. 4 depicts relative small intestine length in pigs fed formulas containing medium chain triglycerides, egg phospholipids, or soy phospholipids.

FIG. 5 depicts relative region weights in pigs fed formulas containing medium chain triglycerides, egg phospholipids, or soy phospholipids.

FIG. 6 depicts relative total small intestine weight in pigs fed formulas containing medium chain triglycerides, egg phospholipids, or soy phospholipids.

### DETAILED DESCRIPTION OF THE DISCLOSURE

Applicants have found that, through the inclusion of phospholipids at a higher level than what is used in nutritional products as an emulsifier, preterm lung maturation can be improved as indicated by an increase in lung surfactant A synthesis. Without intending to be limited by theory, it is believed that dietary phospholipids up-regulate the expression of genes that promote lung maturation.

Applicants have also found that, by increasing the percentage of phospholipids in nutritional compositions to levels higher than what is used in nutritional products as an emulsifier, gut maturation can be increased. Such maturation is observed by increases in the length and weight of the gut. It is believed that such increases in length and weight observed in the gut are due, at least in part, to an increase in intestinal cell size, number, or both, which leads to tighter junction points. Reduced permeability is likely to reduce bacterial or endotoxin translocation, which is believed to contribute to NEC. Without intending to be limited by theory, larger cells are believed to be able to synthesize more protein, leading to increased cell number. Increased cell number, in combination with increases in the size and number of intestinal villi, in turn, is believed to allow for improved nutrient digestion and absorption.

Without intending to be limited by theory, Applicants believe that, in preterm and in some term newborn infants, fat digestion is not completed due to insufficient levels of lipase and bile. Phospholipids are one of the major components of bile. De novo synthesis of phospholipids in term and preterm infants diverts energy from protein synthesis required for growth. In addition, phospholipids are digested into lysophospholipids which are highly functional surfactants. Thus, a high level of dietary phospholipids is likely to facilitate breaking down oil droplets into even smaller droplets, which facilitates fat digestion. Without intending to be limited by theory, it is Applicants' belief that, by providing phospholipids as disclosed herein, the infant body is able to better digest and absorb fat, and use energy that would otherwise be used to synthesize phospholipids to synthesize protein that contributes to gut maturation.

The nutritional compositions disclosed herein provide the required nutritional benefits for growth and maturation to the infant, while providing the infant with the additional significant advantages of improved gut maturation, improved lung development, reduced enterocolitis, and allowing more aggressive enteral nutritional feeding to allow a preterm infant to catch up on growth. The nutritional compositions as described herein may provide an individual, such as an infant, with dependable, high quality nutrition, as well as program the infant early in life such that the infant has a head start to a healthy body shape, improved lung development, and improved general overall health later in life. The nutritional compositions as described herein may provide the infant with nutritional benefits early in life that transcend into significant health benefits later in life allowing the infant to potentially lead a longer, healthier life as a teenager and adult.

These and other optional features of the nutritional compositions and methods of the present disclosure, as well as some of the many other optional variations and additions, are described in detail hereafter.

The terms “nutritional formula” or “nutritional product” or “nutritional composition,” as used herein, are used interchangeably and, unless otherwise specified, refer to nutritional liquids, nutritional powders, nutritional solids, nutritional semi-liquids, semi-solids, nutritional supplements, nutritional tablets, and any other nutritional food product as known in the art, but do not include breast milk. The nutritional powders may be reconstituted to form a nutritional liquid, all of which comprise one or more of fat, protein and carbohydrate, and are suitable for oral consumption by a human. Nutritional formulas include infant formulas.

The term “nutritional liquid,” as used herein, unless otherwise specified, refers to nutritional products in ready-to-drink liquid form, concentrated form, and nutritional liquids made by reconstituting the nutritional powders described herein prior to use.

The term “nutritional powder,” as used herein, unless otherwise specified, refers to nutritional products in flowable or scoopable form that can be reconstituted with water or another aqueous liquid prior to consumption and includes both spray dried and drymixed/dryblended powders.

The term “nutritional semi-solid,” as used herein, unless otherwise specified, refers to nutritional products that are intermediate in properties, such as rigidity, between solids and liquids. Some semi-solids examples include puddings, gelatins, and doughs.

The term “nutritional semi-liquid,” as used herein, unless otherwise specified, refers to nutritional products that are intermediate in properties, such as flow properties, between liquids and solids. Some semi-liquids examples include thick shakes and liquid gels.

The term “infant” as used herein, refers to individuals up to 36 months of age, actual or corrected. In certain embodiments, the term “infant” refers to individuals up to 12 months of age, actual or corrected. The term “preterm infant,” as used herein, refers to an infant born prior to 36 weeks of gestation. The term “term infant,” as used herein, refers to an infant born at or after 36 weeks of gestation. The term “newborn infant,” as used herein, unless otherwise specified, refers to infants less than about 3 months of age, including infants from zero to about 2 weeks of age. “Newborn infant” includes both term and preterm infants.

The term “infant formula,” as used herein, unless otherwise specified, refers to liquid and solid nutritional products suitable for consumption by an infant. Unless otherwise specified herein, the term “infant formula” is intended to encompass both term and preterm infant formulas.

The term “preterm infant formula,” as used herein, unless otherwise specified, refers to liquid and solid nutritional products suitable for consumption by a preterm infant.

The term “later in life,” as used herein, refers to the period of life past infancy.

The terms “susceptible to,” and “at risk of,” as used herein, are used interchangeably to refer to individuals having little resistance to a certain condition or disease, including being genetically predisposed, having a family history of, and/or having symptoms of the condition or disease.

All percentages, parts and ratios as used herein, are by weight of the total composition, unless otherwise specified. All such weights, as they pertain to listed ingredients, are based on the active level and, therefore, do not include solvents or by-products that may be included in commercially available materials, unless otherwise specified.

Numerical ranges as used herein are intended to include every number and subset of numbers within that range, whether specifically disclosed or not. Further, these numerical ranges should be construed as providing support for a claim directed to any number or subset of numbers in that range. For example, a disclosure of from 1 to 10 should be construed as supporting a range of from 2 to 8, from 3 to 7, from 5 to 6, from 1 to 9, from 3.6 to 4.6, from 3.5 to 9.9, and so forth.

All references to singular characteristics or limitations of the present disclosure shall include the corresponding plural characteristic or limitation, and vice versa, unless otherwise specified or clearly implied to the contrary by the context in which the reference is made.

All combinations of method or process steps as used herein can be performed in any order, unless otherwise specified or clearly implied to the contrary by the context in which the referenced combination is made.

The various embodiments of the nutritional compositions of the present disclosure may also be substantially free of any optional or selected essential ingredient or feature described herein, provided that the remaining infant formulas still contain all of the required ingredients or features as described herein. In this context, and unless otherwise specified, the term “substantially free” means that the selected infant formulas contain less than a functional amount of the optional ingredient, typically less than 1%, including less than 0.5%, including less than 0.1%, and also including zero percent, by weight of such optional or selected essential ingredient.

The nutritional compositions and methods of the present disclosure may comprise, consist of, or consist essentially of the essential elements of the products and methods as described herein, as well as any additional or optional element described herein or otherwise useful in nutritional infant formula applications or other applications.

### Product Form

The nutritional compositions of the present disclosure may be formulated and administered in any known or otherwise suitable oral product form. Any solid, liquid, semi-solid, semi-liquid or powder form, including combinations or variations thereof, are suitable for use herein, provided that such forms allow for safe and effective oral delivery to the individual of the essential ingredients as also defined herein.

Specific non-limiting examples of product forms suitable for use with products and methods disclosed herein include, for example, liquid and powder preterm infant formulas, liquid and powder term infant formulas, and liquid and powder elemental and semi-elemental formulas.

The nutritional compositions of the present disclosure are desirably formulated as dietary product forms, which are defined herein as those embodiments comprising the ingredients of the present disclosure in a product form that then contains at least one of fat, protein, and carbohydrate.

The nutritional compositions may be formulated with sufficient kinds and amounts of nutrients to provide a sole, primary, or supplemental source of nutrition, or to provide a specialized nutritional product for use in individuals such as infants afflicted with specific diseases or conditions or with a targeted nutritional benefit.

Desirably, the nutritional compositions include infant formulas formulated for both term and preterm infants. Desirably, the infant formula is formulated for feeding to infants within the first few days, weeks, or months following birth, and including for feeding to infants from age zero to one year, including zero to six months, including zero to four months, and including zero to two months. In some embodiments, the infant formulas are for feeding to newborn infants in the first few weeks of life, including birth to four weeks of life, including birth to three weeks of life, including birth to two weeks of life, and including birth to the first week of life. It is to be understood that the administration of the infant formulas of the present disclosure is not limited to administration during only the first six months following birth, but may be administered to older infants as well.

### Nutritional Liquids

Nutritional liquids include both concentrated and ready-to-feed nutritional liquids. These nutritional liquids include liquids formulated as suspensions, emulsions or clear or substantially clear liquids.

Nutritional emulsions suitable for use include aqueous emulsions comprising proteins, fats, and carbohydrates. These emulsions are generally flowable or drinkable liquids at from about 1° C. to about 25° C. and may be in the form of oil-in-water, water-in-oil, or complex aqueous emulsions, although such emulsions are most typically in the form of oil-in-water emulsions having a continuous aqueous phase and a discontinuous oil phase.

The nutritional liquids include liquids which are shelf stable. The nutritional liquids include liquids which contain up to about 95% by weight of water, including from about 50% to about 95%, also including from about 60% to about 90%, and also including from about 70% to about 85%, of water by weight of the nutritional liquid. The nutritional liquids include liquids which have a variety of product densities, but most typically have a density about 1.01 g/mL or higher, including greater than about 1.02 g/mL, including greater than about 1.03 g/mL, including greater than about 1.04 g/mL, including greater than about 1.055 g/mL, including from about 1.06 g/mL to about 1.12 g/mL, and also including from about 1.085 g/mL to about 1.10 g/mL.

The nutritional liquids include liquids which have a pH ranging from about 3.5 to about 8, but is generally most advantageously in a range of from about 4.5 to about 7.5, including from about 4.5 to about 7.0, including from about 4.5 to about 6.5, including from about 4.5 to about 6.0. In other embodiments, the pH range is from about 5.5 to about 7.3, including from about 5.5 to about 7.0, including from about 5.5 to about 6.5, including from about 6.2 to about 7.2, including from about 6.2 to about 7.0, and including from about 6.2 to about 6.5.

Although the serving size for the nutritional liquid can vary depending upon a number of variables, a typical serving sizes include those which are at least about 2 mL, or even at least about 5 mL, or even at least about 10 mL, or even at least about 25 mL, including ranges from about 2 mL to about 300 mL, including from about 100 mL to about 300 mL, from about 4 mL to about 250 mL, from about 150 mL to about 250 mL, from about 10 mL to about 240 mL, and from about 190 mL to about 240 mL.

### Nutritional Powders

The nutritional powders include powders in the form of flowable or substantially flowable particulate compositions, or at least particulate compositions. Particularly suitable nutritional powder forms include spray dried, agglomerated or dryblended powder compositions, or combinations thereof, or powders prepared by other suitable methods. The compositions can easily be scooped and measured with a spoon or similar other device, wherein the compositions may easily be reconstituted with a suitable aqueous liquid, typically water, to form a nutritional liquid, such as an infant formula, for immediate oral or enteral use. In this context, “immediate” use generally means within about 48 hours, most typically within about 24 hours, preferably right after or within 20 minutes of reconstitution.

### Compositions

### Phospholipids

The various embodiments of the nutritional compositions described herein preferably include from about 3% to about 20% phospholipids, including from about 4% to about 15% phospholipids, and from about 4% to about 10% phospholipids, based on total fat of the nutritional product. In further aspects, the compositions include at least about 1.5 grams of phospholipids per liter of nutritional composition, including at least about 2.5 g/liter, and at least about 3.5 g/liter. The phospholipids may be present in the nutritional composition in these or other amounts, so long as the amount used is effective in enhancing maturation of an infant's lung, gut, or both. The phospholipids may be derived from any suitable source. In some embodiments, the phospholipids are derived from lecithins.

While lecithins are used in the art as emulsifiers in liquid food products including nutritional liquids, lecithins are typically added at relatively low amounts in this capacity, typically about 0.5 to 1% of the total fat, so that the liquid products remain homogeneous and do not separate. Where higher levels of lecithins are used, emulsions are destabilized, forming two layers—an oil-rich and oil-depleted layer. Typical commercial soy lecithin contains about 70% phospholipids, as such, due to these negative properties, lecithins are not typically used at levels described herein.

Lecithins are predominantly a mixture of glycerol phospholipids (e.g., phosphatidylcholine, phosphatidylethanolamine and phosphatidylinositol). Phosphotidlylcholine is typically the major glycerol phospholipid component. Lecithins may also contain other compounds such as free fatty acids, monoglycerides, diglycerides, triglycerides, glycolipids, and other lipid/fatty acid containing compounds. Lecithins are sometimes classified as glycerol phospholipids or phosphotides. This class of compounds has amphiphilic properties and thus emulsifying functionality.

Non-limiting examples of lecithins suitable for use herein include egg lecithin, wheat lecithin, corn lecithin, soy lecithin, modified lecithin, and combinations thereof. Lecithins suitable for use herein may be obtained from any known or otherwise suitable nutrition source. For example, soy lecithin may be obtained from ADM Specialty Food Ingredients, Decatur, Ill., USA, Solae, LLC, St. Louis, Mo., USA, and from American Lecithin Company, Oxford, Conn., USA.

When the nutritional compositions of the present disclosure are in powder form, then the powder is intended for reconstitution to liquid prior to use to obtain the above-noted requirements. Likewise, when the infant formulas of the present disclosure are in a concentrated liquid form, then the concentrate is intended for dilution prior to use to obtain the requisite requirements. The infant formulas can also be formulated as ready-to-feed liquids already having the requisite requirements.

The nutritional compositions of the present disclosure are desirably administered to infants, including preterm, term, and newborn infants, in accordance with the methods described herein. Such methods may include feedings with the infant formulas in accordance with the daily formula intake volumes described herein.

When the nutritional compositions are in the form of an infant formula, the nutritional composition will typically include a combination of protein, carbohydrate and fats. In some embodiments, the protein comprises from about 4% to about 40% of the total calories, including about 15% to about 35%, including from about 10% to about 30%, also including from about 15% to about 25%. The carbohydrate typically comprises less than about 50% of the total calories, including from about 5% to about 50%, including from about 30% to about 50%. In some aspects, the carbohydrate comprises less than about 42% of the total calories, including from about 20% to about 37%. The fat will then make up the remainder of the formula calories, most typically less than about 60% of the calories, including from about 30% to about 60%, including from about 35% to about 55%. Other exemplary amounts of protein, carbohydrate, and fat are set forth hereinafter for use in alternative embodiments. The nutritional composition may include any compatible combination of protein, carbohydrate, and fat (including phospholipids) disclosed herein.

The nutritional compositions may include any protein, carbohydrate, fat, or source thereof that is known for or otherwise suitable for use in an oral nutritional product, provided that the macronutrient is safe and effective for oral administration to infants and is otherwise compatible with the other ingredients in the infant formula. The protein, carbohydrate, and fat can be adjusted as necessary by one skilled in the art based on the disclosure herein to obtain the desired caloric density and protein level.

Although total concentrations or amounts of the protein, carbohydrate, and fat may vary depending upon the product form (e.g., powder or ready-to-feed liquid) and targeted dietary needs of the intended user, such concentrations or amounts most typically fall within one of the embodied ranges described in the following table (each numerical value is preceded by the term “about”), inclusive of any other essential fat, protein, and or carbohydrate ingredients as described herein. For powder embodiments, the amounts in the following Table A are amounts following reconstitution of the powder.

TABLE A

| | Example A | Example B |
|---|---|---|
| Nutrient | (g/100 mL) | (g/100 mL) |
| Protein | 0.5 to 1.5 | 0.6 to 0.9 |
| Fat | 1.2 to 2.5 | 1.4 to 2.3 |
| Carbohydrate | 2.7 to 6.5 | 3.1 to 6.1 |

The level or amount of protein, carbohydrate, and fat in the infant formula (whether a powder formula or a liquid ready-to-feed or concentrated liquid) is additionally or alternatively characterized as a percentage of total calories in the infant formulas. These macronutrients for infant formulas of the present disclosure are most typically formulated within any of the percentage of calorie ranges described in the following Table B (each numerical value is preceded by the term “about”).

TABLE B

| | Example C | Example D | Example E |
|---|---|---|---|
| | (% total | (% total | (% total |
| Nutrient | calories) | calories) | calories) |
| Carbohydrate | 2 to 96 | 10 to 75 | 30 to 50 |
| Protein | 2 to 96 | 5 to 70 | 15 to 35 |
| Fat | 2 to 96 | 20 to 85 | 35 to 55 |
| | Example F | Example G | Example H |
| | (% total | (% total | (% total |
| | calories) | calories) | calories) |
| Carbohydrate | 25 to 50 | 25 to 50 | 35 to 50 |
| Protein | 10 to 30 | 5 to 30 | 7.5 to 25 |
| Fat | 1 to 20 | 2 to 20 | 30 to 60 |

The nutritional compositions may contain any percentage or amount of protein, carbohydrate, and fat described herein in combination with any disclosed percentage or amount of phospholipids so long as the combination is safe and effective for oral administration to infants. In a particular embodiment, the nutritional composition (as administered) includes from about 3% to about 20% phospholipids as a percentage of total fat, from about 15% to about 35% protein, from about 30% to about 50% carbohydrate, and from about 35% to about 55% fat. The amount of phospholipids present is preferably an amount that is effective in enhancing maturation of an infant's lung, gut, or both.

### Protein

Any known or otherwise suitable protein or protein source may be included in the infant formulas of the present disclosure, provided that such proteins are suitable for feeding to infants, and in particular, newborn infants.

Non-limiting examples of suitable protein or sources thereof for use in the infant formulas include hydrolyzed, partially hydrolyzed or non-hydrolyzed proteins or protein sources, which may be derived from any known or otherwise suitable source such as milk (e.g., casein, whey), animal (e.g., meat, fish), cereal (e.g., rice, corn), vegetable (e.g., pea, soy), or combinations thereof. Non-limiting examples of such proteins include milk protein isolates, milk protein concentrates as described herein, casein protein isolates, extensively hydrolyzed casein, whey protein, sodium or calcium caseinates, whole cow milk, partially or completely defatted milk, soy protein isolates, soy protein concentrates, and so forth. The proteins for use herein can also include, or be entirely or partially replaced by, free amino acids known for use in nutritional products, non-limiting examples of which include L-alanine, L-aspartic acid, L-glutamic acid, glycine, L-histidine, L-isoleucine, L-leucine, L-phenylalanine, L-proline, L-serine, L-threonine, L-valine, L-tryptophan, L-glutamine, L-tyrosine, L-methionine, L-cysteine, taurine, L-arginine, L-carnitine, and combinations thereof. Particularly preferred protein sources for use in the infant formulas described herein include non-fat milk and whey protein concentrate. In a particularly preferred embodiment, the non-fat milk and whey protein concentrate is used in combination in the infant formula.

In some embodiments, the infant formulas of the present disclosure include reduced amounts of protein as compared to conventional term and preterm infant formulas. For example, the reduced protein infant formulas include protein in an amount of less than 14.0 grams protein per liter of formula, including from about 5.0 to about 10.0 grams protein per liter of formula, and including from about 7.6 to about 10.0 grams protein per liter of formula.

### Fat

Suitable sources of fat for use in the infant formulas disclosed herein include any fat or fat source that is suitable for use in an oral nutritional product and is compatible with the essential elements and features of such products, provided that such fats are suitable for feeding to infants.

Non-limiting examples of suitable fats or sources thereof for use in the infant formulas described herein include coconut oil, fractionated coconut oil, soybean oil, corn oil, olive oil, safflower oil, high oleic safflower oil, high GLA-safflower oil, oleic acids, MCT oil (medium chain triglycerides), sunflower oil, high oleic sunflower oil, structured triglycerides, palm and palm kernel oils, palm olein, canola oil, flaxseed oil, borage oil, evening primrose oil, blackcurrant seed oil, transgenic oil sources, marine oils (e.g., tuna, sardine), fish oils, fungal oils, algae oils, cottonseed oils, and combinations thereof. In one embodiment, suitable fats or sources thereof include oils and oil blends including long chain polyunsaturated fatty acids (LC-PUFAs). Some non-limiting specific polyunsaturated acids for inclusion include, for example, docosahexaenoic acid (DHA), arachidonic acid (ARA), eicosapentaenoic acid (EPA), linoleic acid (LA), and the like. Non-limiting sources of arachidonic acid and docosahexaenoic acid include marine oil, egg derived oils, fungal oil, algal oil, and combinations thereof. Particularly preferred fat sources include high oleic safflower oil, soy oil, and coconut oils, which may all be used in combination with ARA and/or DHA oil. In one preferred embodiment, the infant formula included a combination of high oleic safflower oil, soy oil, and coconut oil, in combination with ARA oil and DHA oil.

### Carbohydrate

Carbohydrates suitable for use in the nutritional products include any carbohydrates that are suitable for use in an oral nutritional product, such as an infant formula, and that are compatible with the essential elements and features of such product.

Non-limiting examples of suitable carbohydrates or sources thereof for use in the infant formulas described herein include maltodextrin, hydrolyzed, intact, or modified starch or cornstarch, glucose polymers, corn syrup, corn syrup solids, rice-derived carbohydrates, rice syrup, pea-derived carbohydrates, potato-derived carbohydrates, tapioca, sucrose, glucose, fructose, lactose, high fructose corn syrup, honey, sugar alcohols (e.g., maltitol, erythritol, sorbitol), artificial sweeteners (e.g., sucralose, acesulfame potassium, stevia), indigestible oligosaccharides such as fructooligosaccharides (FOS), and combinations thereof. In one embodiment, the carbohydrate includes a maltodextrin having a DE value of less than 20. One preferred carbohydrate is lactose.

### Nucleotides

In some embodiments, the nutritional products of the present disclosure include one or more nucleotides. The nucleotides may be used alone or in combination with any of the other nutritional components as described herein. Administration or consumption of nucleotides can reduce long term adverse health effects of diet in an individual, including long term obesity. “Nucleotides” as used herein includes nucleotides, nucleosides, nucleobases, and combinations thereof, unless otherwise specified in a particular embodiment. Suitable nucleotides include nucleotides with purine bases, pyrimidine bases, ribose and deoxyribose sugars. “Nucleotides” include nucleotides in monophosphate, diphosphate, or triphosphate form. “Nucleotides” also include nucleotides in monomeric, dimeric, or polymeric (including RNA and DNA) form. Also included in the term “nucleotides” are those nucleotides present in the infant formula as a free acid or in the form of a salt, preferably a monosodium salt.

Suitable specific nucleotides and nucleosides for use in the nutritional compositions include one or more of 3′-deoxyadenosine, cytidine 5′-monophosphate, disodium guanosine 5′ monophosphate, disodium uridine 5′ monophosphate, uridine 5′-monophosphate, adenosine 5′-monophosphate, and guanosine 5′-1-monophosphate, Of these, particularly preferred nucleotides include cytidine 5′ monophosphate, disodium guanosine 5′ monophosphate, disodium uridine 5′ monophosphate, adenosine 5′ monophosphate, and combinations thereof. In some embodiments, the nucleotides are in free form and include adenine, cytosine, uracil, guanine, and thymine.

Where present, the nucleotide is present in the infant formulas in total amounts of nucleotides of at least about 10 mg/L, including at least about 72 mg/L of the infant formula, and also including from about 10 mg/L to about 200 mg/L, including from about 10 mg/L to about 150 mg/L, including from about 10 mg/L to about 125 mg/L, and including from about 42 mg/L to about 102 mg/L.

In one specific embodiment, when the infant formula is a nutritional powder, the nucleotide is present at a level of at least about 0.007%, including from about 0.0078% to about 0.1556%, and including about 0.056% (by weight of the nutritional powder), or at least about 0.007 grams, including from about 0.0078 grams to about 0.1556 grams, and including about 0.056 grams of nucleotide per 100 grams of nutritional powder.

In another specific embodiment, when the infant formula is a ready-to-feed nutritional liquid, the nucleotide is present at a level of at least about 0.001%, including from about 0.001% to about 0.0197%, and including about 0.0071% (by weight of the nutritional liquid), or at least about 0.001 grams, including from about 0.001 grams to about 0.0197 grams, and including about 0.0071 grams of nucleotide per 100 grams of ready-to-feed nutritional liquid.

In another specific embodiment, when the infant formula is a concentrated nutritional liquid, the nucleotide is present at a level of at least about 0.0019%, including from about 0.0019% to about 0.0382%, and including about 0.0138% (by weight of the nutritional liquid), or at least about 0.0019 grams, including from about 0.0019 grams to about 0.0382 grams, and including about 0.0138 grams of nucleotide per 100 grams of concentrated nutritional liquid.

### Carotenoids

In some embodiments, the infant formulas of the present disclosure include a carotenoid alone or in combination with any of the other nutritional components as described herein. Administration or consumption of carotenoids can reduce long term adverse health effects of diet in an individual, including long term obesity. The nutritional compositions may include nutritional compositions with one or more carotenoids, and particularly, one or more of the carotenoids lutein, lycopene, zeaxanthin and beta-carotene. In particular embodiments, the nutritional compositions include the carotenoid lutein.

It is generally preferable that the infant formulas include at least one of lutein, lycopene, zeaxanthin, and beta-carotene to provide a total amount of carotenoid of from about 0.001 mg/L to about 5 mg/L, including from about 0.01 mg/L to about 1 mg/L, and including from about 0.1 mg/L to about 0.5 mg/L. More particularly, the infant formulas include lutein in an amount of from about 0.001 μg/mL to about 5 μg/mL, including from about 0.001 μg/mL to about 0.500 μg/mL, including from about 0.01 μg/mL to about 0.250 μg/mL, including from about 0.025 μg/mL to about 0.20 μg/L, and also including from about 0.044 μg/mL to about 0.20 μg/mL of lutein. It is also generally preferable that the infant formulas include from about 0.001 μg/mL to about 5 μg/mL, including from about 0.01 μg/mL to about 0.500 μg/mL, including from about 0.05 μg/mL to about 0.250 μg/mL, including from about 0.055 μg/mL to about 0.130 μg/mL of lycopene. Lycopene may also be included at a concentration of from about 0.0185 μg/mL to about 5 μg/mL of lycopene. It is also generally preferable that the infant formulas include from about 0.001 μg/mL to about 5 μg/mL, including from about 0.001 μg/mL to about 0.500 μg/mL, including from about 0.01 μg/mL to about 0.300 μg/L of beta-carotene, including from about 0.025 μg/L to about 0.200 μg/mL of beta-carotene, and also including from about 0.034 μg/mL to about 0.200 μg/mL of beta-carotene. It should be understood that any combination of these amounts of beta-carotene, lutein, zeaxanthin, and lycopene can be included in the infant formulas of the present disclosure. Other carotenoids may also be included in the infant formulas as described herein. Carotenoids included in the infant formulas disclosed herein include those carotenoids which are from a natural source as well as those which are artificially synthesized.

Each of the carotenoids in the selected combinations can be obtained from any known or otherwise suitable material source for use in infant formulas, and each can be provided individually, or all together, or in any combination and from any number of sources, including sources such as multivitamin premixes containing other vitamins or minerals in combination with one or more of the carotenoids as described herein. Non-limiting examples of some suitable sources of lutein, lycopene, beta-carotene, or combinations thereof include LycoVit® lycopene (available from BASF, Mount Olive, N.J.), Lyc-O-Mato® tomato extract in oil, powder, or bead form (available from LycoRed Corp., Orange, N.J.), beta-carotene, lutein, or lycopene (available from DSM Nutritional Products, Parsippany, N.J.), FloraGLO® lutein (available from Kemin Health, Des Moines, Iowa), Xangold® Natural Lutein Esters (available from Cognis, Cincinnati, Ohio), and Lucarotin® beta-carotene (available from BASF, Mount Olive, N.J.).

### Other Optional Ingredients

The nutritional compositions of the present disclosure include nutritional compositions which include other optional ingredients that may modify the physical, chemical, aesthetic or processing characteristics of the products or serve as pharmaceutical or additional nutritional components when used in the targeted population. Many such optional ingredients are known or otherwise suitable for use in medical food or other nutritional products or pharmaceutical dosage forms and may also be used in the compositions herein, provided that such optional ingredients are safe for oral administration and are compatible with the essential and other ingredients in the selected product form.

Non-limiting examples of such optional ingredients include preservatives, anti-oxidants, emulsifying agents, buffers, fructooligosaccharides, galactooligosaccharides, human milk oligosaccharides and other prebiotics, pharmaceutical actives, additional nutrients as described herein, colorants, flavors, thickening agents and stabilizers, emulsifying agents, lubricants, and so forth, and combinations thereof.

A flowing agent or anti-caking agent may be included in the powder formulas as described herein to retard clumping or caking of the powder over time and to make a powder embodiment flow easily from its container. Any known flowing or anti-caking agents that are known or otherwise suitable for use in a nutritional powder or product form are suitable for use herein, non limiting examples of which include tricalcium phosphate, silicates, and combinations thereof. The concentration of the flowing agent or anti-caking agent in the nutritional product varies depending upon the product form, the other selected ingredients, the desired flow properties, and so forth, but most typically range from about 0.1% to about 4%, including from about 0.5% to about 2%, by weight of the composition.

A stabilizer may also be included in the nutritional compositions. Any stabilizer that is known or otherwise suitable for use in a nutritional product is also suitable for use herein, some non-limiting examples of which include gums such as xanthan gum. The stabilizer may represent from about 0.1% to about 5.0%, including from about 0.5% to about 3%, including from about 0.7% to about 1.5%, by weight of the infant formula.

### Methods of Manufacture

The nutritional compositions of the present disclosure may be prepared by any known or otherwise effective manufacturing technique for preparing the selected product solid or liquid form. Many such techniques are known for any given product form such as nutritional liquids or powders and can easily be applied by one of ordinary skill in the art to the infant formulas described herein.

The nutritional compositions of the present disclosure can therefore be prepared by any of a variety of known or otherwise effective formulation or manufacturing methods. In one suitable manufacturing process, for example, at least two separate slurries are prepared, that are later blended together, heat treated, standardized, and either terminally sterilized to form a retort infant formula or aseptically processed and filled to form an aseptic infant formula. Alternately, the slurries can be blended together, heat treated, standardized, heat treated a second time, evaporated to remove water, and spray dried to form a powder infant formula.

The slurries formed may include a carbohydrate-mineral (CHO-MN) slurry, a protein-water slurry (PIW), and a protein-in-fat (PIF) slurry. Initially, the CHO-MIN slurry is formed by dissolving selected carbohydrates (e.g., lactose, galactooligosaccharides, etc.) in heated water with agitation, followed by the addition of minerals (e.g., potassium citrate, magnesium chloride, potassium chloride, sodium chloride, choline chloride, etc.). Soy lecithin is then added to the CHO-MIN slurry. The resulting CHO-MIN slurry is held with continued heat and moderate agitation until it is later blended with the other prepared slurries. The PIF slurry is formed by heating and mixing the oil (e.g., high oleic safflower oil, soybean oil, coconut oil, monoglycerides, etc.) and emulsifier (e.g., soy lecithin), and then adding oil soluble vitamins, mixed carotenoids, protein (e.g., milk protein concentrate, milk protein hydrolysate, etc.), carrageenan (if any), calcium carbonate or tricalcium phosphate (if any), and ARA oil and DHA oil (in some embodiments) with continued heat and agitation. The resulting PIF slurry is held with continued heat and moderate agitation until it is later blended with the other prepared slurries. PIW is with the CHO-MIN slurry, and the PIF slurry is added under adequate agitation. The pH of the resulting blend is adjusted to 6.6-7.0, and the blend was held under moderate heated agitation. ARA oil and DHA oil is added at this stage in some embodiments. The ratio blends is assembled by blending target amounts of PIW, PIF and CHO/MIN, the blend is then heated and homogenized. Water soluble vitamins are added and the standardized ratio is either spray dried or diluted, filled in appropriate containers, then retorted.

The composition is then subjected to high-temperature short-time (HTST) processing, during which the composition is heat treated, emulsified and homogenized, and then cooled. Water soluble vitamins, any trace minerals and ascorbic acid are added, the pH is adjusted to the desired range if necessary, flavors (if any) are added, and water is added to achieve the desired total solid level. For aseptic infant formulas, the emulsion receives a second heat treatment through an aseptic processor, is cooled, and then aseptically packaged into suitable containers. For retort infant formulas, the emulsion is packaged into suitable containers and terminally sterilized. In some embodiments, the emulsions are heat-treated then spray dried to make a reconstitutable powder. This powder product can be agglomerated or dry blended with other heat labile nutrients.

The spray dried powder nutritional composition or dry-mixed powder nutritional composition may be prepared by any collection of known or otherwise effective techniques, suitable for making and formulating a nutritional powder. For example, when the powder infant formula is a spray-dried nutritional powder, the spray drying step may likewise include any spray drying technique that is known for or otherwise suitable for use in the production of nutritional powders. Many different spray drying methods and techniques are known for use in the nutrition field, all of which are suitable for use in the manufacture of the spray dried powder infant formulas herein. Following drying, the finished powder may be packaged into suitable containers.

### Methods of Use

The nutritional compositions of the present disclosure include infant formulas orally administered to infants, including preterm or term infants. The infant formulas may be administered as a source of nutrition for infants, to prevent and/or reduce and/or minimize and/or eliminate the development and/or onset of tolerance issues related to the use of infant formulas, and/or to enhance maturation of the lungs, gut, or both. One subclass of the general infant population that can effectively utilize the infant formulas described herein include those infants that are susceptible to, or at a risk of (at an elevated risk as compared to the general infant population) one or more of tolerance and respiratory issues. These infants who are susceptible to or at risk of having tolerance and/or respiratory issues are herein referred to as “in need of” assistance (or “in need thereof” as referring to the assistance needed) in combating infant formula tolerance and/or combating respiratory issues.

Based on the forgoing, because some of the method embodiments of the present disclosure are directed to specific subsets or subclasses of infants (that is, the subset or subclass of infants that are “in need” of assistance in addressing infant formula tolerance or respiratory issues) in those embodiments, not all infants can benefit from all method embodiments described herein as not all infants will fall within the subset or subclass of infants as described herein.

The infant formulas will typically be administered daily, at intake volumes suitable for the age of the infant. For instance, in some embodiments, the methods of the present disclosure include methods of administering one or more of the formulas of the present disclosure to an infant at the average intake volumes described herein. In other embodiments, newborn infants are provided with increasing formula volumes during the initial weeks of life. Such volumes most typically range to up to about 100 mL/day on average during the first day or so of life; up to about 200 to about 700 mL/day, including from about 200 to about 600 mL/day, and also including from about 250 to about 500 mL/day, on average during the remainder of the three month newborn feeding period. It is to be understood, however, that such volumes can vary considerably depending upon the particular newborn infant and their unique nutritional needs during the initial weeks or months of life, as well as the specific nutrients and caloric density of the infant formula administered.

In some embodiments, the methods of the present disclosure are directed to infants during the initial days, weeks or months of life. Desirably, in some embodiments, the infant formulas described herein are administered to the infant for a duration of at least the first week of life, more desirably during at least the first two weeks of life, more desirably during at least the first one or two months of life, more desirably during at least the first four months of life, and more desirably during at least the first six months of life, and including up to the first year of life. Thereafter, the infant may be switched to a conventional infant formula, alone or in combination with human milk. It should be understood by one skilled in the art based on the disclosure herein that the infant formulas described herein can be used alone, or in combination with human breast milk, or in combination with other infant formulas.

The infant formulas used in the methods described herein, unless otherwise specified, are nutritional formulas and may be in any product form, including ready-to-feed liquids, concentrated liquids, reconstituted powders, and the like as described above. In embodiments where the infant formulas are in powder form, the method may further comprise reconstituting the powder with an aqueous vehicle, most typically water or human milk, to form the desired caloric density, which is then orally or enterally fed to the infant. The powdered formulas are reconstituted with a sufficient quantity of water or other suitable fluid such as human milk to produce the desired caloric density, as well as the desired feeding volume suitable for one infant feeding. The infant formulas may also be sterilized prior to use through retort or aseptic means.

In one aspect, the present disclosure is directed to a method of providing nutrition to an infant. The method comprises administering to the infant one or more of the infant formulas of the present disclosure. Such methods include methods where the infant formulas are administered on a daily basis, including administration at the daily intake volumes as described hereinbefore. In some embodiments, the infant to whom the formula is administered is a newborn infant.

In other aspects, the present disclosure is directed to a method of enhancing maturation of an infant's lungs, gut, or both. The method comprises administering to the infant one or more of the infant formulas of the present disclosure. In some embodiments, the infant to whom the formula is administered is a preterm infant. In some other embodiments, the infant to whom the formula is administered is a term infant.

In some aspects, the present disclosure is directed to improving lung maturation in an individual. In some aspects, individuals with improved lung maturation are identified by measuring the level of lung surfactant A protein synthesis from lung tissue in the individual both before and after administration of a nutritional composition as disclosed herein to the individual. Individuals with improved lung maturation are identified as those individuals exhibiting increased lung surfactant A protein synthesis following the administration. The level of lung surfactant A protein synthesis is measured by any method known in the art. In some embodiments, lung surfactant A protein synthesis is measured by western blot.

In other aspects, the present disclosure is directed to improving gut maturation in an individual. In some aspects, individuals with improved gut maturation are identified by increases in weight following administration of a nutritional composition disclosed herein.

In another aspect, improved maturation of the gut, lung, or both in an individual, and, particularly, an infant, is identified by measuring changes in weight, lung surfactant A protein synthesis, and/or small intestine size (i.e., length or weight) in a model organism following administration of a nutritional composition disclosed herein to the model organism. The model organism can be any known model organism for measuring these properties. In some embodiments, the model organism is a pig, and, in particular, a piglet.

### EXAMPLES

The following examples illustrate specific embodiments and/or features of the infant formulas and methods of the present disclosure. The examples are given solely for the purpose of illustration and are not to be construed as limitations of the present disclosure, as many variations thereof are possible without departing from the spirit and scope of the disclosure. Unless otherwise specified, the retort sterilized formulas, which may be prepared in accordance with the manufacturing methods described herein, are ready-to-feed liquid formulas. All exemplified amounts are weight percentages based upon the total weight of the composition, unless otherwise specified. All ingredient amounts are listed as kilogram per 1000 kilogram batch of product, unless otherwise specified.

### Example 1

### Effect of Dietary Phospholipids on Preterm Piglet Lung Associated Protein a Synthesis and Necrotizing Enterocolitis

Materials and Methods

Preterm pigs were harvested by c-section at 91% of term from artificially inseminated (timed pregnancy), specific pathogen free sows of a consistent genetic line. Within 2-4 h after delivery the pigs were weighed, an umbilical artery catheter (UAC) and orogastric feeding tube were inserted, and parenteral nutrition (PN) was started via the UAC at a rate of 8 ml/kg-h. Maternal plasma was provided to each pig as a single bolus (5 ml/kg) after the UAC was placed to provide passive immunity. Antibiotics were not intended to be administered as this would compromise the necrotizing enterocolitis (NEC) model, but were mistakenly administered to one litter. The preterm pigs were housed individually in temperature regulated incubators.

PN was provided for 48 h for all but one litter in Phase 1, which was provided PN for 24 h. At conclusion of the PN period the pigs were converted to full enteral nutrition (EN) using bolus feeding at a rate of 15 ml/kg every 3 h (120 ml/kg-day). The period of EN was limited to 48 h because of rapid onset and high mortality caused by NEC, which precluded 72 h feeding periods. To address possible size (birth weight) influences, at the end of PN the pigs in each litter were distributed by relative size at birth (small, medium, and large) to groups. Pigs in each group were randomly assigned to one of the three EN groups that were used in each of the two phases. This approach for distributing the pigs to treatments ensured sizes of pigs in each of the three groups were comparable.

Pigs that developed symptoms of NEC (e.g., bloating, lethargy, poor perfusion, unresponsive, labored breathing, decreasing heart rate, diarrhea with or without overt blood) were euthanized before death (if possible) and the gut, liver, spleen and lung were harvested, observed, and findings recorded (i.e., location and severity of NEC lesions). The severity of NEC lesions was scored using a 6 point system that we apply for the preterm pig model. Pigs that survived the 48 h of EN were euthanized for collection of and observations of the entire gut for NEC lesions. Blood samples were collected via the UAC prior to death.

Table C. shows the three formulations used: Control, Egg PL, and Soy lecithin. Soy lecithin alone (Soy lecithin), MCT oil alone (Control) or MCT+egg lecithin (Egg PL) were added to a basal sow milk replacer containing 30% protein and 25% fat during reconstitution.

TABLE C
Formulations

| Diet reconstitution (grams per Kg of feed) | | | | | |
|---|---|---|---|---|---|
| | | Egg | Soy | | |
| | powder | Phospholipids | lecithin | MCT oil | Water |
| Control | 200 | | | 10 | 790 |
| Egg PL | 200 | 7 | | 3 | 790 |
| Soy lecithin | 200 | | 10 | | 790 |

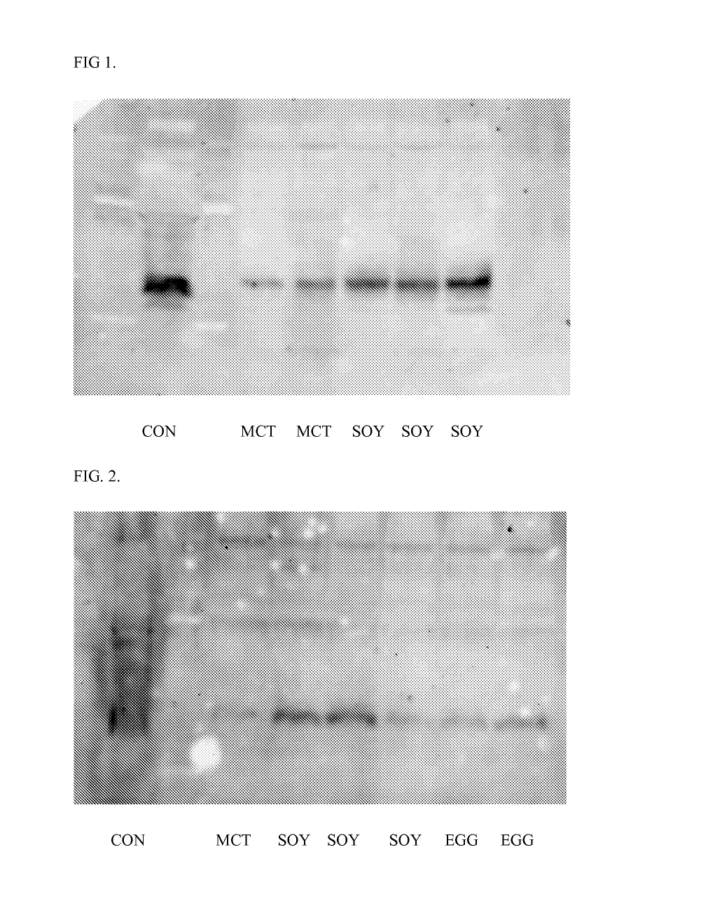

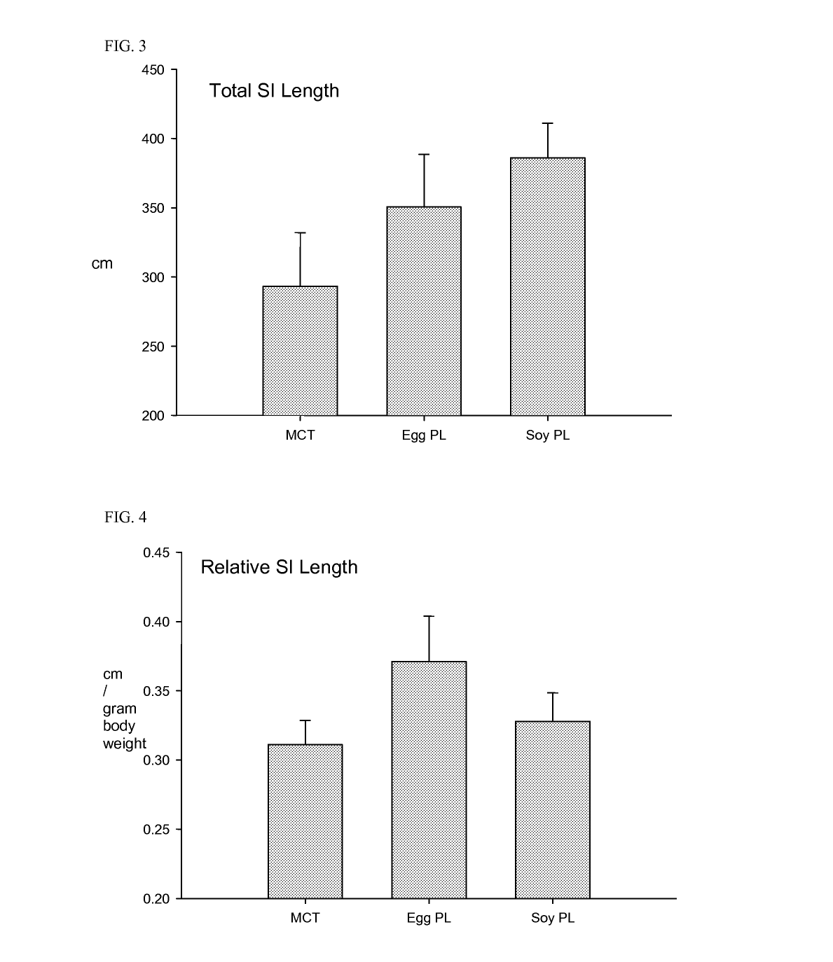

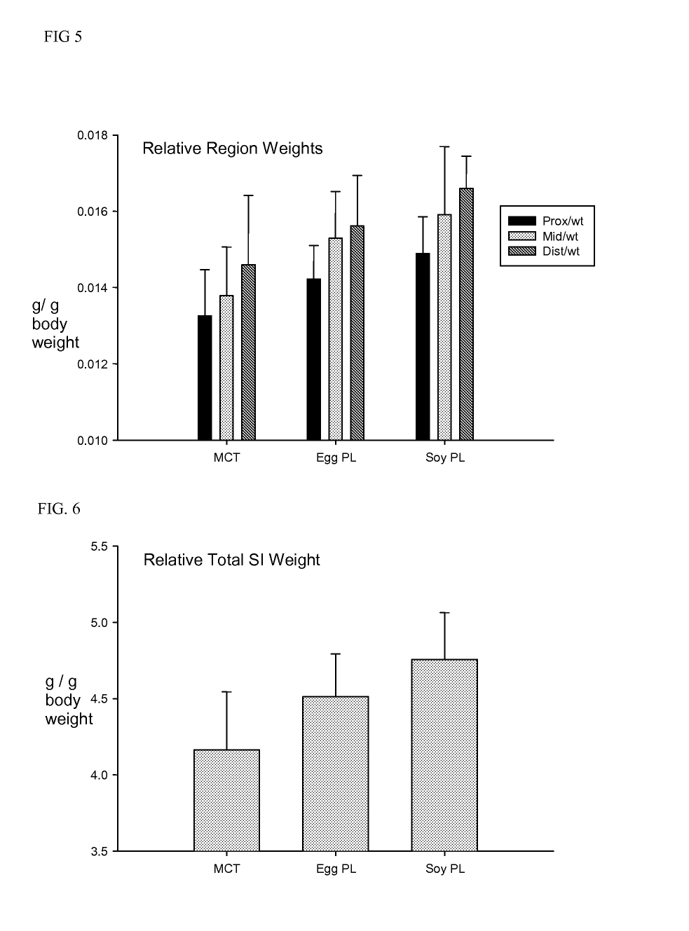

Results are shown in Table D and FIGS. 1-6. As shown in Table D, inclusion of phospholipids (PL) reduced NEC rate (NEC Incidence) from 71% to about 30%. The inclusion of PL also appears to enhance lung maturation as indicated by the increase in lung surfactant A protein synthesis (MCT vs. SOY or MCT vs. EGG) shown by western blots for lung surfactant A protein from lung homogenate in FIGS. 1 and 2. Pigs on formulas containing phospholipids gained more weight than those on control diets. The inclusion of phospholipids appears to enhance gut maturation as indicated by increases in the intestine length and weight (See, e.g., FIGS. 3-6). It appears that PL enhanced gut maturation which lead to better nutrient digestion and absorption, and, in turn, growth rate.

TABLE D
Results.

| | MCT | Egg PL | Soy PL |
|---|---|---|---|
| Number of pigs at start of EN | 14 | 16 | 15 |
| Birth weight (g) | 1049 + 51 | 1008 + 55 | 1008 + 44 |
| Body wt at necropsy (g) | 1186 + 62 | 1177 + 69 | 1184 + 49 |
| NEC Incidence (%) | 10/14 (71) | 4/16 (25) | 5/15 (33) |
| NEC severity (0-6 scoring) | 2.12 + 0.33 | 1.58 + 0.25 | 1.85 + 0.32 |
| Survival rate after 48 h of EN | 64% | 87% | 100% |
| % weight gain from birth | 13.3 + 2.1 | 16.8 + 0.8 | 16.9 + 1.0 |
| Blood urea nitrogen (BUN) | 16.4 + 2.4 | 14.2 + 0.9 | 12.8 + 1.4 |
| (mmol/liter) | | | |
| Blood glucose (mg/dl) | 59.2 ± 6.8 | 51.9 ± 3.1 | 53.9 ± 5.7 |

### CONCLUSIONS

In addition to enhancing nutrient digestion and absorption, it is believed that the inclusion of a high level of dietary phospholipids upregulate genes that promote lung maturation.

### Example 2

### Exemplary Nutritional Composition

An example of a nutritional composition suitable for use in the methods as described herein is provided below in Table E. 1000 lbs. of nutritional composition in powder form is made by adding the ingredients (Ingredient) in the number of pounds shown (Ex. 2). Certain ingredients are added as needed (AN).

TABLE E
Exemplary ingredients for making 1000
lbs. of a powdered composition

| Ingredient (lbs.) | Ex. 2 |
|---|---|
| Non-fat dried milk | 198 |
| Whey protein | 48.7 |
| Lactose | 413 |
| High oleic safflower oil | 105 |
| Soybean fatty acids | 55.2 |
| Monoglyceryl palmitate | 65.8 |
| Coconut oil | 48 |
| Soy lecithin | 28.6 |
| Galactooligosaccharides | 69.50 |
| Whey protein concentrate | 51.08 |
| Potassium citrate | 0.37 |
| Calcium hydroxide | 8 |
| ARA oil | 2.91 |
| Nucleotide/chloride premix | 2.347 |
| Potassium chloride | 1.6 |
| Ascorbic acid | 1.275 |
| Vitamin mineral premix | 1.116 |
| Vitamin C | 1.87 |
| DHA | 1.45 |
| Magnesium chloride | 0.78 |
| Ferrous sulfate | 0.44 |
| Choline chloride | 0.75 |
| Vitamin ADEK premix | 0.38 |
| Ascorbyl Palmitate | 0.36 |
| Mixed carotenoid premix | 0.19 |
| Mixed Tocopherols | 0.16 |
| L-carnitine | 0.03 |
| Riboflavin | 0.02 |
| Potassium phosphate monobasic | 4.67 |
| Potassium hydroxide | AN |

1. A method of enhancing maturation of a lung, gut, or both in an infant, the method comprising the step of administering to the infant a nutritional composition comprising from about 3 weight % phospholipids to about 20 weight % phospholipids, based on total fat of the nutritional composition.

2. The method of claim 1, wherein the nutritional composition comprises from about 4 weight % to about 15 weight % phospholipids, based on the total fat of the nutritional composition.

3. The method of claim 1, wherein the nutritional composition comprises from about 4 weight % to about 10 weight % phospholipids, based on the total fat of the nutritional composition.

4. The method of claim 1, wherein the nutritional composition comprises at least about 1.5 g/liter of phospholipids.

5. The method of claim 1, wherein the phospholipids are derived from a lecithin.

6. The method of claim 5, wherein the lecithin is selected from the group consisting of egg lecithin, wheat lecithin, corn lecithin, soy lecithin, modified lecithin, and combinations thereof.

7. The method of claim 1, wherein the infant is a preterm infant.

8. The method of claim 1, wherein the infant is a term infant.

9. The method of claim 1, wherein the nutritional composition further comprises from about 15% to about 35% protein; from about 30% to about 50% carbohydrate; and from about 35% to about 55% fat; wherein the nutritional composition comprises an amount of phospholipids that is effective in enhancing maturation of the infant's lung, gut, or both.

10. The method of claim 1, wherein the nutritional composition further comprises a carotenoid.

11. The method of claim 10, wherein the carotenoid is selected from the group consisting of lutein, lycopene, zeaxanthin, beta-carotene, and combinations thereof.

12. The method of claim 11, wherein the carotenoid is lutein.

13. The method of claim 1, wherein the nutritional composition further comprises from about 42 mg/L to about 102 mg/L of a nucleotide.

14. The method of claim 13, wherein the nucleotide is selected from the group consisting of cytidine 5′ monophosphate, disodium guanosine 5′ monophosphate, disodium uridine 5′ monophosphate, adenosine 5′ monophosphate, and combinations thereof.

15. The method of claim 1, wherein the nutritional composition is a nutritional liquid.

16. The method of claim 1, wherein the nutritional composition is a nutritional powder.

17. The method of claim 1, wherein the method enhances lung maturation in the infant.

18. The method of claim 1, wherein the method enhances gut maturation in the infant.
